(19) United States
(12) Patent Application Publication
(10) Pub. No.: US 2002/0128773 A1
(43) Pub. Date: Sep. 12, 2002

(54) Multiple navigation routes based on user preferences and real time parameters

(76) Inventors: Andrea Bowes Chowanic, Farmington Hills, MI (US); Mark Edward Porter, Dearborn, MI (US); Thomas Joseph Hermann, Troy, MI (US)

Correspondence Address: BROOKS & KUSHMAN P.C./FGTI, 1000 TOWN CENTER, 22ND FLOOR, SOUTHFIELD, MI, 48098, US

(21) Appl. No.: 09/802,587

(22) Filed: Mar. 9, 2001

(51) Int. Cl. G01C 21/34

(52) U.S. Cl. 701/210; 340/995

(57) ABSTRACT

A navigation system and method incorporating the use of a navigation system that provides alternate routes to an initially selected route based upon updated, real time parameters. The system is provided with user preference data that is used when developing the initial route and alternate routes. The system may be programmed to only provide alternate routes if a predetermined improvement in efficiency is potentially available.

### BACKGROUND OF THE INVENTION

1. Field of the Invention

The present invention relates to a method of utilizing a navigation system that provides alternative routes to a preselected route that are generated in response to changes in a set of real time parameters.

2. Background Art

Navigation systems have been developed for land vehicles that include a global positioning system (GPS) and a data processor that is provided with map data. Most navigation systems that have previously been developed provide a single route based upon a single user preference. For example, a route may be plotted by the data processor to provide the route that best suits a user's stated preference such as the route that is the shortest time, shortest distance, requires maximum or minimum use of freeways, requires maximum or minimum use of toll roads, or is based upon available traffic information.

These methods often do not provide a route that the user actually prefers. Such methods generally do not offer alternate routes. One approach that provides alternate routes is disclosed in U.S. Pat. No. 5,220,507.

Some systems offer a detour approach when the user deviates from the preselected route. One example of such a system is disclosed in U.S. Pat. No. 5,291,413. However, this type of system requires that the user instruct the system to recompute the route and does not provide an automatically generated alternative route.

Another drawback of currently available navigation systems is that the conditions along a preselected route may change while driving. For instance, a traffic accident, new construction area or weather conditions could change the advisability of taking a particular route. One problem with prior art systems is that many different types of real time data could impact optimum route selection depending upon the preferences of an individual.

There is a need for a system that offers optional routing along the way with intelligence as to a user's preferences and filtering of information provided to a driver based upon a level of increased efficiency as measured by one or more parameters.

The present invention addresses the above problems and other problems associated with prior art navigation systems and provides an improved navigation system as summarized below.

### SUMMARY OF THE INVENTION

According to the present invention, a navigation system is provided for a vehicle that provides alternative routing while traversing a previously selected route. The navigation system comprises a data processor having a database of routing information over which a land vehicle may travel. The data processor is programmable with a starting point and a destination point and provides a user selectable route between the starting point and the destination point that is selected prior to beginning traversing the route. A global positioning system (GPS) provides a set of current location data corresponding to the current location of the vehicle. The data processor is capable of providing alternative routes to the destination point based upon the set of current location data, user preference data, and a set of updated real time parameters. The data processor may provide the user with alternative routing while traversing the previously selected route.

According to another aspect of the invention, the user preference data may comprise criteria such as shortest time, shortest distance, maximizing use of freeways, minimizing use of freeways, maximizing use of toll roads, and minimizing use of toll roads.

According to yet another aspect of the navigation system of the present invention, a set of real time parameters may comprise traffic data, weather data, train schedule data, draw bridge schedule data, construction zone data, and special event data. The available real time parameters may be used by the data processor to calculate an alternate route. The previously selected route is compared to the alternate route and information is provided to the driver to evaluate and select between the previously selected route and the alternate route in response to updates of real time parameters that are reviewed by the data processor while the driver travels along the selected route.

According to another aspect of the invention, the information may be provided to the driver to evaluate and select between the previously selected route and the alternative route on a selective basis only when the alternate route would provide a predetermined improvement in efficiency as measured by a selected parameter.

According to the method of navigating to a destination of the present invention, a data processing system receives inputs of a starting location, a destination location, a set of real time parameters, and a set of user preferences. The data processing system calculates at least one route from the starting point to the destination including factoring in real time parameters and user preferences. The user selects one of the routes and travels along the route toward the destination. Real time parameters are updated while the user travels along the selected route. The data processing system calculates an alternate route from an intermediate location to the destination location based upon the updated set of real time parameters. The system then compares a selected route to the alternate route and provides information to the driver to evaluate and choose between the previously selected route and the alternate route. The choice of the driver is thereafter considered to be the selected route for the continuation of traveling to the destination location.

According to another aspect of the method of the present invention, the steps of updating the set of real time parameters, calculating an alternate route, comparing the previously selected route to the alternate route are repeated in response to each update of the real time parameters while traveling along the selected route.

The step of providing information to the driver to evaluate and select between the previously selected route and the alternate route is repeated upon receiving a request from the user or when the alternate route would provide a predetermined degree of improvement in efficiency in reference to at least one selected user preference. For example, the step of providing information to the user may alternatively be repeated only when the alternative route results in a reduction in the time of travel from the intermediate location to the destination location.

According to another aspect of the method of the present invention, the real time parameters may comprise traffic data, weather data, train schedule data, draw bridge schedule data, construction zone data, and special event data.

These and other aspects of the system and method of the present invention will be better understood by one of ordinary skill in the art in view of the attached drawings and in light of the following detailed description of the invention.

### BRIEF DESCRIPTION OF THE DRAWINGS

FIG. 1 is a flowchart showing the method of navigating to a destination utilizing a data processing system in accordance with the present invention.

### DETAILED DESCRIPTION OF THE PREFERRED EMBODIMENT

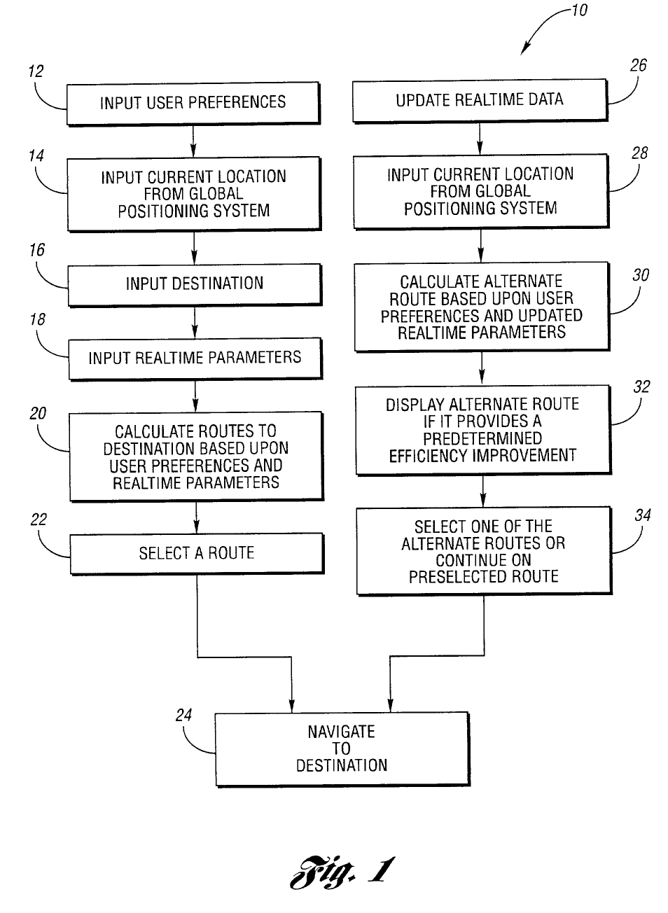

Referring now to FIG. 1, a method of navigating to a destination utilizing a data processing system according to the present invention is generally referred to by reference numeral 10. The user preferences are input at 12 into the data processing system. The user preferences may include criteria such as selecting the shortest time, shortest distance, maximizing or minimizing the use of freeways, and maximizing or minimizing the use of toll roads.

The current location data is input from a global positioning system at 14 to the data processing system.

The destination is input at 16. Real time parameters are input at 18. Examples of real time parameters include traffic data, weather data, train schedule data, draw bridge schedule data, construction zone data, and special event data. Other real time parameters may be weighed and may include, but are not limited to, the following data: crime data; road classification data; map database data such as road speed, interpreted use of roads, bridge height, road usage restrictions (weight, flammable materials, etc.), number of lanes, number of traffic lights/stop signs.

The data processing system calculates a route to the destination based upon user preferences and real time parameters at reference numeral 20. The system may recommend several different routes to a user who would then select the route at 22. Once the route is selected, the user navigates to the destination 24.

If there are changes to the real time data, the real time data is updated at 26. For example, if data is received relating to a traffic jam caused by an accident on the selected route, it is provided to the data processor. The data processor would also be provided with current location information from the global positioning system at 28. The data processing system calculates an alternate route based upon the user preferences and updated real time parameters at 30. The data processing system would then display to the user an alternate route if it provides a predetermined efficiency improvement at 32. The user may then select one of the alternate routes or continue on the previously selected route at 34. The user may then navigate to the destination at 24 on either the alternate route or on the preselected route.

While the system anticipates the availability of real time parameters such as traffic information, weather information, and the like, if such information is not available, the system simply does not utilize the information.

The invention is intended to allow maximization of use of information and it is anticipated that additional data sources will be made available via radio or digital transmissions. Data processors are capable of utilizing all available data and generating user information that may lead to the development of several different routes.

The system has the capability of allowing a user to select a route as he is approaching an intersection where an alternate route may be initiated. While the system described above would limit display of alternative routes unless they provide a predetermined efficiency improvement, the system may also provide the user with options at each intersection with potential alternate routes. The coding or recommendation of alternate routes would be weighed based upon both user preferences in light of real time parameters.

The system may also be provided with information regarding the current speed or progress of the vehicle along the preselected route that could also be used as a real time parameter. If the car speed is below the anticipated speed or if the progress of the vehicle along the preselected route is delayed, the system may evaluate this information as a real time parameter and calculate an alternate route.

Multiple alternate routes may be displayed in text or graphical form, and may be coded, for example, red, green and yellow to indicate a best alternate route versus second and third choices. The display may use color codings for different routes depending upon their correlation with user preferences. While suggested routes may be displayed with color coding, it would also be possible to provide alpha numeric ranking or suitable icons for identifying suggested alternate routes.

The method of the present invention continuously offers alternative routes without the need for user queries. However, the system would permit access by a user to request an alternative route if it is not automatically provided. This may occur if the user driving the car notices a traffic problem that has not been reported to the data processing system by digital broadcast or otherwise.

While the best mode for carrying out the invention has been described in detail, those familiar with the art to which this invention relates will recognize various alternative designs and embodiments for practicing the invention as defined by the following claims.

What is claimed:

1. A navigation system for a vehicle that provides routing information while traversing a route, comprising:
a data processor having a database of routing information over which a land vehicle may travel, the data processor being programmable with a starting point and a destination point, the data processor being provided with user preference data, the data processor being provided with realtime parameters that are used in providing previously selected route between the starting point and the destination point that is selected prior to beginning traversing the route;
a global positioning system (GPS) providing a set of current location data corresponding to the current location of the vehicle;
the data processor providing an alternative route to the destination point based upon the set of current location data, user preference data and a set of updated realtime parameters that provides the user with the alternative route while traversing the previously selected route.

2. The navigation system of claim 1 wherein the user preference data comprises criteria such as shortest time, shortest distance, maximizing use of freeways, minimizing use of freeways, maximizing use of toll roads, and minimizing use of toll roads.

3. The navigation system of claim 1 wherein the set of real time parameters comprises traffic data, weather data, train schedule data, draw bridge schedule data, construction zone data, and special event data, that are used by the data processor depending upon availability in calculating an alternate route, comparing the previously selected route to the alternate route, and providing information to driver to evaluate and select between the previously selected route and the alternate route repeatedly in response to each update of the real time parameters while traveling along the selected route.

4. The navigation system of claim 3 wherein the information provided to the driver to evaluate and select between the previously selected route and the alternate route is selectively provided only when the alternate route would provide a predetermined improvement in efficiency as measured by a selected parameter.

5. A method of navigating to a destination utilizing a data processing system:
inputting a starting location;
inputting a destination location;
inputting a set of real time parameters;
inputting a set of user preferences;
calculating at least one route from the staring point to the destination including factoring in the effect of the real time parameters and user preferences;
selecting one of the routes and traveling along a selected route toward the destination;
updating the set of real time parameters to create an updated set of real time parameters while traveling along the selected route;
calculating an alternate route from an intermediate location to the destination location based upon the updated set of real time parameters;
comparing the selected route to the alternate route; and
providing information to driver to evaluate and choose between the selected route and the alternate route, the choice of the driver thereafter being the selected route for the continuation of traveling to the destination location.

6. The method of navigating to a destination of claim 5 wherein the steps of updating the set of real time parameters, calculating an alternate route, comparing the previously selected route to the alternate route, are repeated in response to each update of the real time parameters while traveling along the selected route and the step of providing information to driver to evaluate and select between the previously selected route and the alternate route is repeated upon receiving a request from the user or when the alternate route would provide a predetermined degree of improvement in efficiency in reference to at least one selected user preference.

7. The method of navigating to a destination of claim 6 wherein the step of providing information to the user is repeated only when the alternate route results in a reduction of the time of travel from the intermediate location to the destination location.

8. The method of navigating to a destination of claim 6 wherein the step of providing information to the user is repeated only when the alternate route results in a reduction of the cost of travel from the intermediate location to the destination location.

9. The method of navigating to a destination of claim 5 wherein the realtime parameters are selected from the group consisting essentially of:
traffic data;
weather data;
train schedule data;
draw bridge schedule data;
construction zone data; and
special event data.

10. The method of navigating to a destination of claim 5 wherein the real time parameters are data that may be provided to the data processor that could impact the time or cost of travel to the destination location.

11. The method of claim 5 wherein the starting location and intermediate location are input from a global positioning system.
